(19) United States
(12) Patent Application Publication
(10) Pub. No.: US 2018/0001204 A1
(43) Pub. Date: Jan. 4, 2018

(54) SYSTEM AND METHODS FOR FACILITATING LIVE FANTASY SPORTS PLATFORM

(71) Applicant: FANTASY65 BVI, Road Town (VG)

(72) Inventors: Barak EISENSTEIN, TEL-AVIV (IL); Asaf CARMEL, PETAH-TIKVA (IL); Moshe INGBER, TEL-AVIV (IL)

(73) Assignee: FANTASY65 BVI, Road Town (VG)

(21) Appl. No.: 15/196,515

(22) Filed: Jun. 29, 2016

(51) Int. Cl. A63F 13/65; A63F 13/828; A63F 13/35

(52) U.S. Cl. CPC A63F 13/65; A63F 13/35; A63F 13/828

(57) ABSTRACT

The present invention extends to methods, systems, and devices for facilitating live fantasy sports platform, comprising obtaining primary metadata comprising a plurality of sets of statistics values, each value being associated with of one or more real-life players' performance metrics and one or more event factors; processing the primary data to generate secondary data, wherein secondary data additionally comprises a plurality of sets of incorporating users' decision-making characteristics and event factors comprising stochastic and/or probabilistically-determined values associated with each factor throughout the real-life sporting event, as it unfolds and changes in real-time; providing, using computer simulation techniques, the secondary data to a dynamic real-time platform having a physics engine to generate a computer-based data layer over the real-life sporting event wherein users compete against one another to win the event; and generating visual output to a user presenting a computer-based data layer over the real-life sporting event wherein users compete against one another to win the event, throughout the real-life sporting event, as it unfolds and changes in real-time.

### FIELD OF THE INVENTION

The present invention relates generally to the field of fantasy sports, and the software used in a preferred embodiment, having an integrated real-time platform that allows a user to dynamically select one or more real-life games of each player occurring during a real-life event comprising real-life statistics generated by each player during the selected real-life games that are used to determine if the user is a winner based on the user's selection in the particular real-life event.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

Fantasy sports is a game where participants act as owners to build a team that competes against other fantasy owners based on the statistics generated by the real individual players or teams of a sport. Usually statistical performances are converted into points that are compiled and totaled according to a roster selected by a manager (or owner) that makes up a fantasy team. More complex variants use computer modeling of actual games based on statistical input generated by professional sports. In fantasy sports there is sometimes the ability to trade, cut, and sign players, like a real sports owner. A typical fantasy sport league can require a large time commitment for at least an entire season and can also require a large amount of work to do research about teams and players. With real-time engagement of users, as a sports event happening in real-time, improvements to the game and its application to new areas can increase the interest and its dynamic engagement in the game. With the purpose of changing and adding to the way fantasy sports games are played, various systems and methods for creating an online, virtual live interactive video game that uses fantasy sports statistics exist in the art.

Fantasy sports live, by Jose A Sanchez., discloses the method of playing the online live interactive fantasy video game of the invention comprises a obtaining a subscription to play, selecting a platform from which to play the fantasy game, selecting team members to form a fantasy team, interacting with others playing the fantasy game, and controlling each team member's performance and competing against other fantasy teams. The game includes access to a live fantasy sports television channel to watch games and tournaments, live access to a fantasy sports analyst, and virtual reality software so that the player can become physically involved with the game.

Designing a real sports companion match-play crowdsourcing electronic game, by Mindforce Consulting LLC, discloses developing a match-play game in which an outcome of a live event determines an outcome within the match-play game comprises several steps including determining a set of outcomes that may occur in the live event, presenting the set of outcomes to a game designer, presenting a design interface in which a game designer may create a match-play game, enabling a user to determine a set of outcomes that may occur in the match-play game, and enabling the user to associate at least one outcome in the match-play game to an outcome in the live event.

As presented, certain levels of real-time engagement in fantasy sports exist. However, none of the current technologies and prior art, taken alone or in combination, address nor provide a solution for facilitating an integrated real-time platform that allows a user to dynamically select one or more real-life games of each player as they occur during a real-life event comprising real-life statistics generated by each player before and during the selected real-life games that are used to determine if the user is a winner based on the user's selection in the particular real-life event.

Therefore, there is a long felt and unmet need for a system and method that overcomes the problems associated with the prior art.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

It is thus an object of the present invention to provide a data processing system for facilitating live fantasy sports platform, the data processing system comprising a bus system; a communications unit coupled to the bus system; a memory coupled to the bus system, wherein the memory includes a set of instructions; and a processing unit coupled to the bus system, wherein the processing unit is operable to cause execution of the set of instructions to perform the following steps: obtaining primary metadata comprising a plurality of sets of statistics values, each value being associated with of one or more real-life players' performance metrics and one or more event factors; processing the primary data to generate secondary data, secondary data additionally comprises a plurality of sets of incorporating users' decision-making characteristics and event factors comprising stochastic and/or probabilistically-determined values associated with each factor throughout the real-life sporting event, as it unfolds and changes in real-time; providing, using computer simulation techniques, the secondary data to a dynamic real-time platform having a physics engine to generate a computer-based data layer over the real-life sporting event, where users compete against one another to win the event; and generating visual output to a user presenting a computer-based data layer over the real-life sporting event wherein users compete against one another to win the event, throughout the real-life sporting event, as it unfolds and changes in real-time.

It is another object of the present invention to provide a method for generating live fantasy sports platform, the method comprising the computer-executed steps of: obtaining primary metadata comprising a plurality of sets of statistics values, each value being associated with of one or more real-life players' performance metrics and one or more event factors; processing the primary data to generate secondary data, the secondary data additionally comprises a plurality of sets of incorporating users' decision-making characteristics and event factors comprising stochastic and/or probabilistically-determined values associated with each factor throughout the real-life sporting event, as it unfolds and changes in real-time; providing, using computer simulation techniques, the secondary data to a dynamic real-time platform having a physics engine to generate a computer-based data layer over the real-life sporting event wherein users compete against one another to win the event; and generating visual output to a user presenting a computer-based data layer over the real-life sporting event where users compete against one another to win the event, throughout the real-life sporting event, as it unfolds and changes in real-time.

It is another object of the present invention to provide a non-transitory computer-readable medium storing software comprising instructions executable by one or more computers which, upon such execution, cause the one or more computers to perform operations comprising: obtaining primary metadata comprising a plurality of sets of statistics values, each value being associated with of one or more real-life players' performance metrics and one or more event factors; processing the primary data to generate secondary data, wherein secondary data additionally comprises a plurality of sets of incorporating users' decision-making characteristics and event factors comprising stochastic and/or probabilistically-determined values associated with each factor throughout the real-life sporting event, as it unfolds and changes in real-time; providing, using computer simulation techniques, the secondary data to a dynamic real-time platform having a physics engine to generate a computer-based data layer over the real-life sporting event wherein users compete against one another to win the event; and generating visual output to a user presenting a computer-based data layer over the real-life sporting event wherein users compete against one another to win the event, throughout the real-life sporting event, as it unfolds and changes in real-time.

### BRIEF DESCRIPTION OF THE PREFERRED EMBODIMENTS

The novel features believed to be characteristics of the invention are set forth in the appended claims. The invention itself, however, as well as the preferred mode of use, further objects and advantages thereof, will best be understood by reference to the following detailed description of illustrative embodiment when read in conjunction with the accompanying drawings, wherein:

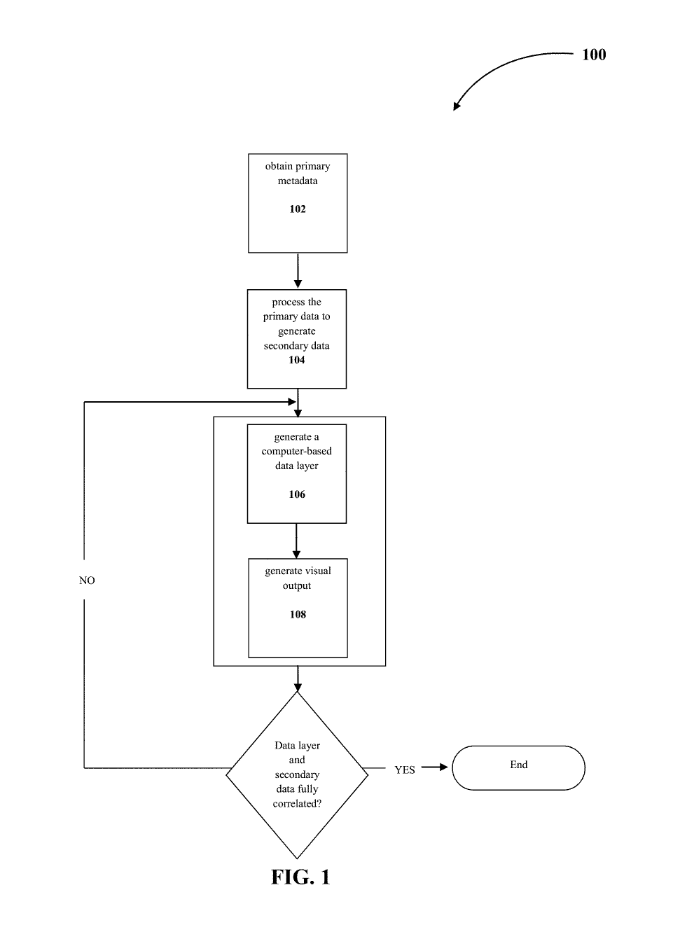

FIG. 1 presents a high level data flow diagram of the method disclosed by the present invention;

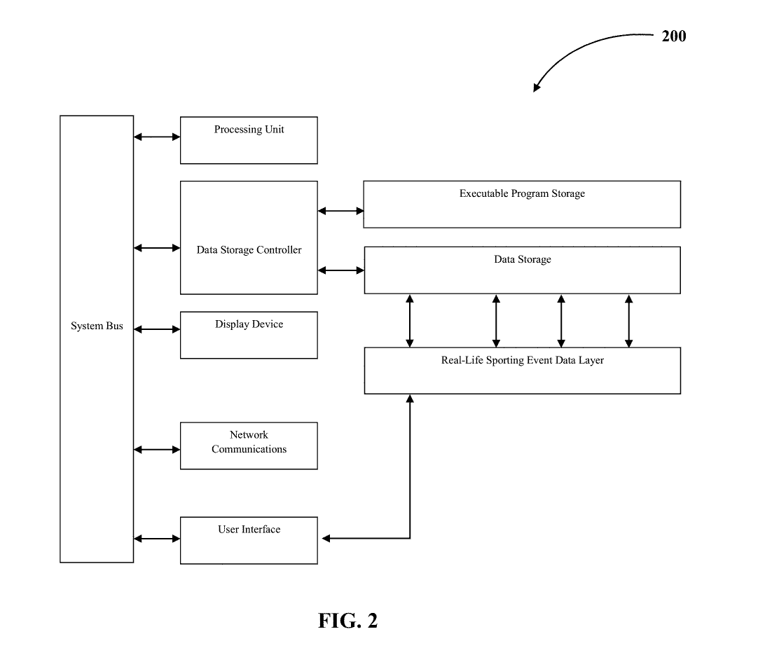

FIG. 2 presents an embodiment of the computer system disclosed by the present invention; and

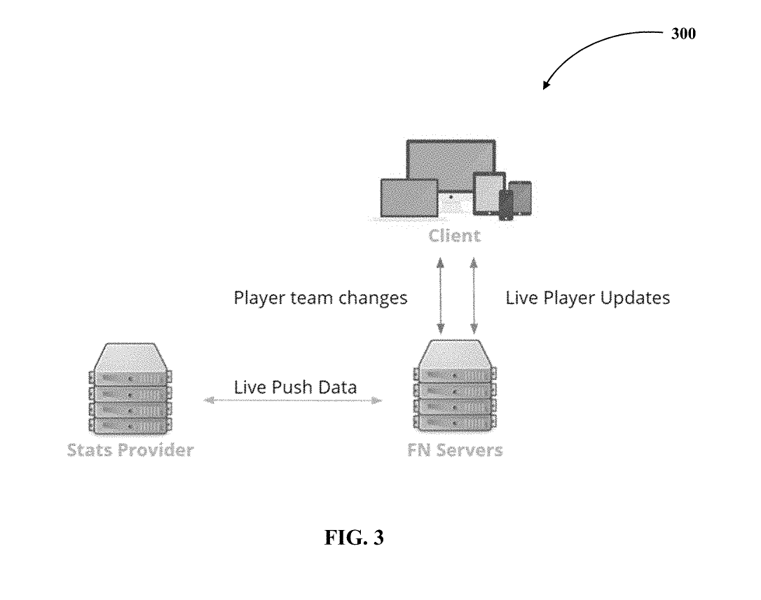

FIG. 3 presents an embodiment of the stat and update system disclosed by the present invention.

### DETAILED DESCRIPTION OF THE PREFERRED EMBODIMENTS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present description of embodiments, discussions utilizing terms such as “obtaining”, “facilitating”, “processing”, “performing,” “extracting,” “configuring” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices, including integrated circuits down to and including chip level firmware, assembler, and hardware based micro code.

As will be explained in further detail below, the technology described herein relates to generating, storing and using semantic networks and databases to correlate physiological and psychological states of users and/or groups of users using their voice intonation data analysis.

While the invention is susceptible to various modifications and alternative forms, specific embodiments thereof have been shown by way of example in the drawings and the above detailed description. It should be understood, however, that it is not intended to limit the invention to the particular forms disclosed, but on the contrary, the intention is to cover all modifications, equivalents, and alternatives falling within the spirit and scope of the invention as defined by the appended claims.

The term “user” used interchangeably in the present invention, refers hereinafter to any party that employs an integrated real-time platform that allows the user to dynamically select one or more real-life games of each player occurring during a real-life event comprising real-life statistics generated by each player during the selected real-life games that are used to determine if the user is a winner based on the user's selection in the particular real-life event.

The term “mobile device” interchangeably refers, but not limited to such as a mobile phone, laptop, tablet, wearable computing device, cellular communicating device, digital camera (still and/or video), PDA, computer server, video camera, television, electronic visual dictionary, communication device, personal computer, and etc. The present invention means and methods are performed in a standalone electronic device comprising at least one screen. Additionally or alternatively, at least a portion of such as processing, memory accessible, databases, includes a cloud-based platform, and/or web-based platform. In some embodiments, the software components and/or image databases provided, are stored in a local memory module and/or stored in a remote server.

As a non-limiting example, the facilitating live fantasy sports platform method can be executed using a computerized process according to the example method 100 illustrated in FIG. 1. As illustrated in FIG. 1, the method 100 can first obtain primary metadata 102 comprising a plurality of sets of statistics values, each value being associated with of one or more real-life players' performance metrics and one or more event factors from a gaming database before the real-life sporting event, in a real world environment and update the primary data from the gaming database during the real-life sporting event, in a real world environment; process the primary data 104 to generate secondary data, secondary data additionally comprises a plurality of sets of incorporating users' decision-making characteristics and event factors comprising stochastic and/or probabilistically-determined values associated with each factor throughout the real-life sporting event, as it unfolds and changes in real-time; provide, using computer simulation techniques, the secondary data to a dynamic real-time platform having a physics engine to generate a computer-based data layer 106 over the real-life sporting event, where users compete against one another to win the event; and generate visual output 108 to a user presenting a computer-based data layer over the real-life sporting event wherein users compete against one another to win the event, throughout the real-life sporting event, as it unfolds and changes in real-time.

Reference is made now to FIG. 2 which graphically illustrates, according to another preferred embodiment of the present invention, an example of computerized system for implementing the invention 200. The systems and methods described herein can be implemented in software or hardware or any combination thereof. The systems and methods described herein can be implemented using one or more computing devices which may or may not be physically or logically separate from each other. Additionally, various aspects of the methods described herein may be combined or merged into other functions.

In some embodiments, the illustrated system elements could be combined into a single hardware device or separated into multiple hardware devices. If multiple hardware devices are used, the hardware devices could be physically located proximate to or remotely from each other.

The methods can be implemented in a computer program product accessible from a computer-usable or computer-readable storage medium that provides program code for use by or in connection with a computer or any instruction execution system. A computer-usable or computer-readable storage medium can be any apparatus that can contain or store the program for use by or in connection with the computer or instruction execution system, apparatus, or device.

A data processing system suitable for storing and/or executing the corresponding program code can include at least one processor coupled directly or indirectly to computerized data storage devices such as memory elements. Input/output (I/O) devices (including but not limited to keyboards, displays, pointing devices, etc.) can be coupled to the system. Network adapters may also be coupled to the system to enable the data processing system to become coupled to other data processing systems or remote printers or storage devices through intervening private or public networks. To provide for interaction with a user, the features can be implemented on a computer with a display device, such as an LCD (liquid crystal display), virtual display, or another type of monitor for displaying information to the user, and a keyboard and an input device, such as a mouse or trackball by which the user can provide input to the computer.

A computer program can be a set of instructions that can be used, directly or indirectly, in a computer. The systems and methods described herein can be implemented using programming languages such as Flash™, JAVA™, C++, C, C#, Visual Basic™, JavaScript™, PHP, XML, HTML, etc., or a combination of programming languages, including compiled or interpreted languages, and can be deployed in any form, including as a stand-alone program or as a module, component, subroutine, or other unit suitable for use in a computing environment. The software can include, but is not limited to, firmware, resident software, microcode, etc. Protocols such as SOAP/HTTP may be used in implementing interfaces between programming modules. The components and functionality described herein may be implemented on any desktop operating system executing in a virtualized or non-virtualized environment, using any programming language suitable for software development, including, but not limited to, different versions of Microsoft Windows™, Apple™ Mac™, iOS™, Android™, Unix™/X-Windows™, Linux™ etc. The system could be implemented using a web application framework, such as Ruby on Rails.

The processing system can be in communication with a computerized data storage system. The data storage system can include a non-relational or relational data store, such as a MySQL™ or other relational database. Other physical and logical database types could be used. The data store may be a database server, such as Microsoft SQL Server™, Oracle™, IBM DB2™ SQLITE™, or any other database software, relational or otherwise. The data store may store the information identifying syntactical tags and any information required to operate on syntactical tags. In some embodiments, the processing system may use object-oriented programming and may store data in objects. In these embodiments, the processing system may use an object-relational mapper (ORM) to store the data objects in a relational database. The systems and methods described herein can be implemented using any number of physical data models. In one example embodiment, an RDBMS can be used. In those embodiments, tables in the RDBMS can include columns that represent coordinates. In the case of environment tracking systems, data representing user events, virtual elements, etc. can be stored in tables in the RDBMS. The tables can have pre-defined relationships between them. The tables can also have adjuncts associated with the coordinates.

Suitable processors for the execution of a program of instructions include, but are not limited to, general and special purpose microprocessors, and the sole processor or one of multiple processors or cores, of any kind of computer. A processor may receive and store instructions and data from a computerized data storage device such as a read-only memory, a random access memory, both, or any combination of the data storage devices described herein. A processor may include any processing circuitry or control circuitry operative to control the operations and performance of an electronic device.

The processor may also include, or be operatively coupled to communicate with, one or more data storage devices for storing data. Such data storage devices can include, as non-limiting examples, magnetic disks (including internal hard disks and removable disks), magneto-optical disks, optical disks, read-only memory, random access memory, and/or flash storage. Storage devices suitable for tangibly embodying computer program instructions and data can also include all forms of non-volatile memory, including, for example, semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The systems, modules, and methods described herein can be implemented using any combination of software or hardware elements. The systems, modules, and methods described herein can be implemented using one or more virtual machines operating alone or in combination with each other. Any applicable virtualization solution can be used for encapsulating a physical computing machine platform into a virtual machine that is executed under the control of virtualization software running on a hardware computing platform or host. The virtual machine can have both virtual system hardware and guest operating system software.

The systems and methods described herein can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks that form the Internet.

One or more embodiments of the invention may be practiced with other computer system configurations, including hand-held devices, microprocessor systems, microprocessor-based or programmable consumer electronics, minicomputers, mainframe computers, etc. The invention may also be practiced in distributed computing environments where tasks are performed by remote processing devices that are linked through a network.

Reference is made now to FIG. 3 which graphically illustrates, according to another preferred embodiment of the present invention, an example of computerized system for facilitating stats and updates of the invention 200. The systems and methods described herein facilitate a platform to construct a team of players and manage their team live during the sport match, providing a real second screen experience to the game. As all the players full stats update in real time users can decide on their actions based on the data received within the app or by watching the game and compete against other users and win prizes. The distributed network platform uses a push update via client module. An example of the platform includes a game play scenario wherein one or more users construct a five players team from one of that day matches; once the game starts the user can change his team players to any of the other players in both team in order to maximize his final number of fantasy points. Once a player has been swapped, the number of fantasy points he made up to that points is kept and will be added to the number of points the new player makes; once the match is over, the points for each game position will remain the same. The number of player swaps is limited and once a swap has been made it can take up to a predefined period of time for the swap to actually take place and the player's scores to be added to the user's points. Example game options include a team that is made out of five players (GoalKeeper, Defender, two Midfielders and an Attacker). The user can select any player before the match (there is no salary limit) once the game start the user can select only active players (players in the roster). To maximize the number of fantasy points the user can swap player during the match. Number of swaps is limited to six on each half and two in a case of extra time. In a case of Team Captain, the team captain gets three times the number of fantasy points of a regular player; captain swap is limited to three times. Example game scoring rules include goal +10 points; assist +6 points; shot +1 point; shot on goal +1 point; cross +1 point; foul drawn +1 point; fouls conceded −0.5 points; tackle won +1 point; pass intercepted (D,M,F) +0.5 points; yellow card −1 point; red card −3 points; penalty kick miss −5 points; save (GK) +2 points; goal conceded (GK) −2 points; penalty kick save (GK) +3 points.

1. A data processing system for facilitating live fantasy sports platform, the data processing system comprising a bus system; a communications unit coupled to the bus system; a memory coupled to the bus system, wherein the memory includes a set of instructions; and a processing unit coupled to the bus system, wherein the processing unit is operable to cause execution of the set of instructions to perform the following steps:
a. obtaining primary metadata comprising a plurality of sets of statistics values, each value being associated with of one or more real-life players' performance metrics and one or more event factors;
b. processing the primary data to generate secondary data, wherein secondary data additionally comprises a plurality of sets of incorporating users' decision-making characteristics and event factors comprising stochastic and/or probabilistically-determined values associated with each factor throughout the real-life sporting event, as it unfolds and changes in real-time;
c. providing, using computer simulation techniques, the secondary data to a dynamic real-time platform having a physics engine to generate a computer-based data layer over the real-life sporting event wherein users compete against one another to win the event; and
d. generating visual output to a user presenting a computer-based data layer over the real-life sporting event wherein users compete against one another to win the event, throughout the real-life sporting event, as it unfolds and changes in real-time.

2. The data processing system of claim 1, wherein the data processing system is configured to receive the primary data from a gaming database before the real-life sporting event, in a real world environment.

3. The data processing system of claim 1, wherein the data processing system is configured to update the primary data from a gaming database during the real-life sporting event, in a real world environment.

4. A data processing system of claim 1, wherein the computer-based data layer is generated over any type of sport or skill based event, including sporting events such as a horse race, an auto race, a stock car race, a Formula 1 race, a NASCAR race, a boxing match, a kick boxing match, an ultimate fight match, a wrestling match, a basketball game, a soccer game, a rugby game, a football game, a baseball game, a hockey game, a lacrosse match, a dog race, a greyhound race, a harness race, a steeplechase and any other combinations of skill based games and wagering events.

5. The data processing system of claim 1, wherein the data processing system is configured to facilitate an integrated betting engine to allow users throughout the real-life sporting event to place wagers on the outcome of the real-life sporting event utilizing either a pari-mutuel/exchange betting or a fixed odds system, as it unfolds and changes in real-time.

6. A method of generating live fantasy sports platform, the method comprising the computer-executed steps of:
a. obtaining primary metadata comprising a plurality of sets of statistics values, each value being associated with of one or more real-life players' performance metrics and one or more event factors;
b. processing the primary data to generate secondary data, wherein secondary data additionally comprises a plurality of sets of incorporating users' decision-making characteristics and event factors comprising stochastic and/or probabilistically-determined values associated with each factor throughout the real-life sporting event, as it unfolds and changes in real-time;
c. providing, using computer simulation techniques, the secondary data to a dynamic real-time platform having a physics engine to generate a computer-based data layer over the real-life sporting event wherein users compete against one another to win the event; and
d. generating visual output to a user presenting a computer-based data layer over the real-life sporting event wherein users compete against one another to win the event, throughout the real-life sporting event, as it unfolds and changes in real-time.

7. The method of claim 6, wherein obtaining the primary data comprises receiving the primary data from a gaming database before the real-life sporting event, in a real world environment.

8. The method of claim 6, wherein obtaining the primary data comprises updating the primary data from the gaming database during the real-life sporting event, in a real world environment.

9. The method of claim 6, wherein generating the computer-based data layer comprises generating the computer-based data layer over any type of sport or skill based event, including sporting events such as a horse race, an auto race, a stock car race, a Formula 1 race, a NASCAR race, a boxing match, a kick boxing match, an ultimate fight match, a wrestling match, a basketball game, a soccer game, a rugby game, a football game, a baseball game, a hockey game, a lacrosse match, a dog race, a greyhound race, a harness race, a steeplechase and any other combinations of skill based games and wagering events.

10. The method of claim 6, wherein the method further comprises a step of facilitating an integrated betting engine to allow users throughout the real-life sporting event to place wagers on the outcome of the real-life sporting event utilizing either a pari-mutuel/exchange betting or a fixed odds system, as it unfolds and changes in real-time.

11. A non-transitory computer-readable medium storing software comprising instructions executable by one or more computers which, upon such execution, cause the one or more computers to perform operations comprising:
a. obtaining primary metadata comprising a plurality of sets of statistics values, each value being associated with of one or more real-life players' performance metrics and one or more event factors;
b. processing the primary data to generate secondary data, wherein secondary data additionally comprises a plurality of sets of incorporating users' decision-making characteristics and event factors comprising stochastic and/or probabilistically-determined values associated with each factor throughout the real-life sporting event, as it unfolds and changes in real-time;
c. providing, using computer simulation techniques, the secondary data to a dynamic real-time platform having a physics engine to generate a computer-based data layer over the real-life sporting event wherein users compete against one another to win the event; and
d. generating visual output to a user presenting a computer-based data layer over the real-life sporting event wherein users compete against one another to win the event, throughout the real-life sporting event, as it unfolds and changes in real-time.

12. The non-transitory computer-readable medium of claim 11, wherein obtaining the primary data comprises receiving the primary data from a gaming database before the real-life sporting event, in a real world environment.

13. The non-transitory computer-readable medium of claim 11, wherein obtaining the primary data comprises updating the primary data from the gaming database during the real-life sporting event, in a real world environment.

14. The non-transitory computer-readable medium of claim 11, wherein generating the computer-based data layer comprises generating the computer-based data layer over any type of sport or skill based event, including sporting events such as a horse race, an auto race, a stock car race, a Formula 1 race, a NASCAR race, a boxing match, a kick boxing match, an ultimate fight match, a wrestling match, a basketball game, a soccer game, a rugby game, a football game, a baseball game, a hockey game, a lacrosse match, a dog race, a greyhound race, a harness race, a steeplechase and any other combinations of skill based games and wagering events.

15. The non-transitory computer-readable medium of claim 11, wherein the method further comprises a step of facilitating an integrated betting engine to allow users throughout the real-life sporting event to place wagers on the outcome of the real-life sporting event utilizing either a pari-mutuel/exchange betting or a fixed odds system, as it unfolds and changes in real-time.
